(19) United States
(12) Patent Application Publication
(10) Pub. No.: US 2022/0200193 A1
(43) Pub. Date: Jun. 23, 2022

(54) BATTERY CONNECTOR FOR ELECTRIC BICYCLE

(71) Applicant: HIRSCHMANN AUTOMOTIVE GMBH, Rankweil/Brederis (AT)

(72) Inventors: Manuel LINSEDER, Rankweil (AU); Andreas JAKOB, Schlins (AU)

(21) Appl. No.: 17/598,760

(22) PCT Filed: Apr. 8, 2020
(86) PCT No.: PCT/EP2020/060024

§ 371 Date: Sep. 27, 2021

(30) Foreign Application Priority Data
Apr. 10, 2019 (DE) 10 2019 109 421.6

(51) Int. Cl. H01R 13/52; B62M 6/90; H01R 13/74

(52) U.S. Cl. CPC H01R 13/5202; H01R 2201/26; H01R 13/743; B62M 6/90

(57) ABSTRACT

A plug-in connection (1), comprising an electrical connector (2) and a mating electrical connector (3), which can be plugged together with the electrical connector, the electrical connector (2) having a housing, which has a flange (5) and a frame (7), the frame comprising at least one contact chamber (8), in which a contact partner (9) is arranged, the mating electrical connector (3) having a housing and a frame (12), the frame comprising a contact chamber (13), in which at least one contact partner (14) is arranged, characterized in that each contact partner (14) of the mating electrical connector (3) is surrounded by a casing (15), which surrounds the contact partner (14) except from the insertion region for an associated contact partner (9) of the electrical connector (2).

The invention relates to a plug-in connection comprising a male connector and a female connector that can be plugged together, the male connector having a housing and a collar forming at least one contact chamber holding a contact, the female connector having a housing and a collar forming a contact chamber holding at least one contact, according to the features of the preamble of claim 1.

In particular, the invention relates to a plug for a battery of an electric bicycle (e-bike battery). The battery with a nominal voltage of 42 volts (or possibly greater) is intended to be pivotable into the frame of the bicycle. In addition, the contacts must be protected against contact according to the known IPXXB standard, since voltages equal to or greater than 42V are present here. Since this voltage can be present on both the pin side (male connector) and the socket side (female connector), the required contact protection applies to both parts of the plug-in connection. Furthermore, the discharge interface must meet IP67 sealing requirements in the plugged position.

The object of the invention is to provide a plug-in connection comprising a male connector and a female connector that can be plugged together and that is improved with regard to the process of plugging together from a safety point of view.

This object is achieved by the features of claim 1.

According to the invention, it is provided that each contact of the female connector is surrounded by a shell that surrounds the contact except for the insertion region for an associated contact of the male connector. While, in a manner known per se, it is provided that the male connector has at least one contact chamber, wherein the contact arranged in this contact chamber is recessed with respect to the free end of the collar of the male connector in accordance with the invention (in order to prevent this at least one contact from being touched by a finger, a part of the hand, a tool or the like, in order to ensure protection against contact), it is provided in a further manner according to the invention that each contact of the female connector, wherein all contacts (one contact or more than one contact) are surrounded by a collar, is surrounded by a shell. This shell protects the contact from contact, in order to provide a contact protection for the female connector as well. However, that part of the contact that is to be plugged together with the corresponding contact of the male connector for the purpose of electrical contacting is free to the extent that the contact of the male connector can be inserted into this insertion region of the contact of the female connector. Also in this arrangement of the female connector, some of the contacts or preferably all of the contacts can, but do not have to, be set back relative to the free projecting generally annular edge of the collar, so that the generally annular edge of the collar prevents contact with the free insertion region of the at least one contact of the female connector.

Both the male connector and the female connector can be arranged at the end of a cable with at least one electrical conductor in each case, which is electrically contacted with an associated contact. Such an arrangement may be designed to be freely movable. It is also conceivable that the male connector and/or the female connector, preferably both, are each fixed at an intended installation location. The one installation location is, for example, a component of a vehicle, in particular an electric bicycle (there, for example, a frame of the bicycle), wherein the other installation location is the housing of an energy source (such as a battery). The housings of the male connector as well as the female connector are either configured to both be suitable for plugging together in alignment in the axial direction. Since in electric bicycles the battery is often inserted into the frame, or in other arrangements in electric bicycles or in general, it is necessary that the male connector is placed at an angle against the female connector and moved further into it. This movement is a kind of pivoting in, so that ultimately the male connector, or its housing, is aligned in the female connector, or housing thereof, when these two elements have been plugged together as intended and have reached their end position.

In order to make it possible to pivot the plug-in connection, a contact system was selected that permits an oblique insertion angle of 10° (±50%, preferably ±25%, preferably ±15%, further preferably ±5%, in particular exactly 10°). The housing parts, in turn, were designed with lead-in slopes so that the plug-in connection can be pivoted in. In order to ensure protection against contact in accordance with IPXXB despite the free pin contacts, according to the invention the contacts are individually encapsulated. Contact with the test finger is thus excluded. The encapsulation of the pins means that the socket contacts cannot sit in a closed contact chamber as usual. The contact chambers for the sockets were accommodated in individual domes, wherein the chambers were recessed at certain points to accommodate the stiffening ribs of the geometry of the encapsulation of the pins.

For this insertion or pivoting process described above, it is further provided in accordance with the invention that a seal is provided in a free end region of the collar of the male connector and a bevel cooperating with the seal during the plugging process is provided in a free end region of the collar of the female connector. The presence of the bevel has the advantage that the male connector can be guided further into the female connector after insertion. The bevel thus achieves a defined guidance during the plugging process. This guidance is further reinforced by the fact that a deformable seal is arranged in the free end region of the collar of the male connector. The outer surface of this seal can initially slide over the bevel into the inner surface of the collar of the female connector, so that the insertion or pivoting-in process is significantly improved with a defined guide, wherein the seal also provides a seal of the inner region (within the collars of the male connector and the female connector) of the plug-in connection after the insertion or pivoting-in process has been completed.

In a refinement of the invention, it is provided that the male connector and/or the female connector has a latch element for the purpose of its latching fixation at its intended installation location. This makes it possible to mount both the male connector and/or the female connector quickly and easily as well as in the correct position in the housing of the installation location, for example the frame of the electric bicycle, and/or in the housing of the further installation location, for example the housing of a battery.

In a refinement of the invention, it is provided that the housing of the male connector has a flange in which at least one hole is arranged and/or the housing of the female connector has a flange in which at least one hole is arranged. This makes it possible to arrange the housing of the male connector and/or of the female connector simply, quickly and permanently at the installation location by a screw connection (by the flange, a defined and positionally correct arrangement at the installation location is ensured) and to fix it (by a screw that can be passed through the particular hole). Instead of a screw connection, a connection by rivets can also be used.

In order to support the permanent fixing of the male connector and/or the female connector at the particular installation location and also to ensure operational safety at the installation location, in a further refinement of the invention it is additionally also provided that the male connector and/or the female connector has a seal that, after fixing at its intended installation location, is arranged between the installation location and the housing of the male connector or the female connector. The latched fixing of the male connector or the female connector at its installation location in cooperation with the seal results not only in the desired sealing, but also in a permanent fixing, which contributes to an increase in operational safety.

The invention thus relates to a male connector or a female connector, having at least one contact, preferably a plurality of contacts, wherein the male connector or the female connector is pivotably arranged on a base, characterized in that each contact is encapsulated in the unplugged position for the purpose of contact protection.

An exemplary embodiment of a plug-in connection according to the invention is described below and explained with reference to the drawing.

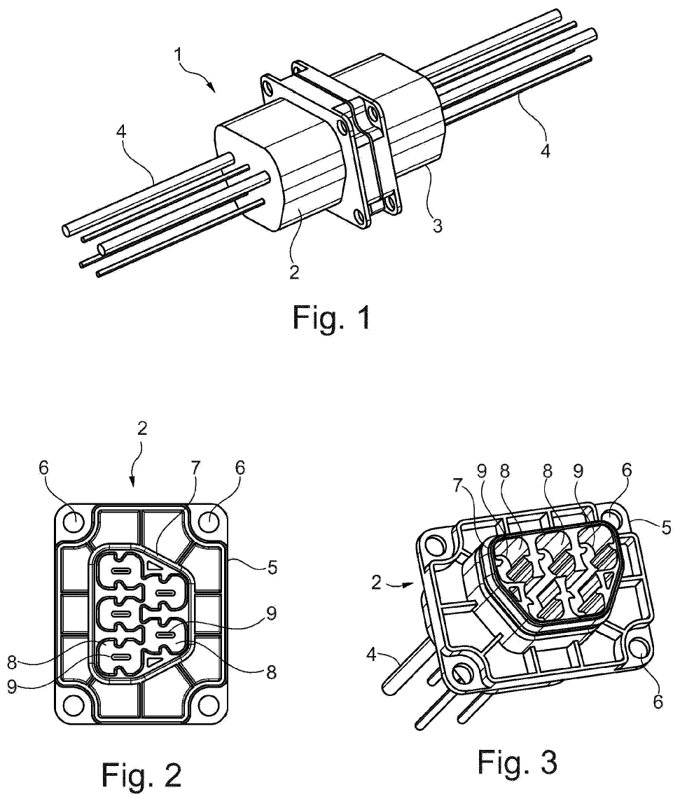

FIGS. 1 to 5 show, as far as is depicted in detail, a plug-in connection 1 having a male connector 2 and a female connector 3 that can be plugged into each other. The two connectors 2 and 3 of the plug-in connection 1 are each mounted on the end of a respective single-core or multi-core cable 4.

FIGS. 2 and 3 show detailed views of the male connector 2. A housing of the male connector 2, which is not designated in greater detail, has a flange 5 that has at least one hole 6, here in this embodiment a hole 6 at each corner of the rectangular flange 5, with which the housing of the male connector 2 can be fixed at its installation location, for example by screws. This at least one hole 6 can but does not have to be present. In particular, it can be omitted if the male connector 2 is fixed at its installation location by at least one latch element, an adhesive bond, a press fit or the like.

Furthermore, the housing of the male connector 2 has a collar 7 forming at least one contact chamber 8, in this embodiment five such contact chambers 8 are formed by the collar 7. A contact 9 is provided in each contact chamber 8. Each contact 9 is shown to be recessed relative to the free outer edge of the respective collar 7 and webs formed within the latter separate the contact chambers 8, so that the ends of the respective contacts 9 cannot touch a hand, finger or the like past the front end of the housing of the male connector 2 in the region of the collar 7.

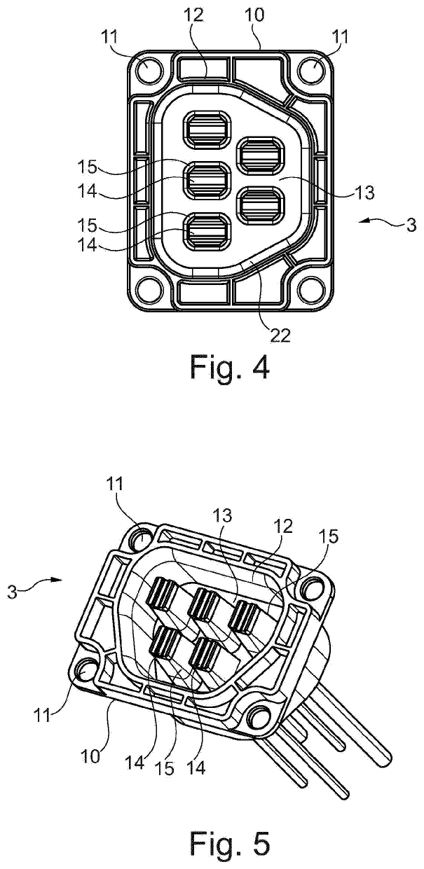

In FIGS. 4 and 5, the design of the associated female connector 3 is also shown in various views. This female connector 3 also has a housing that has (can have, but as with the male connector 2 does not have to have) a flange 10. Analogously to the flange of the male connector 2, the flange 10 of the female connector 3 also has a mounting hole 11 at each of its four corners. Furthermore, there is a collar 12 that forms a single contact chamber 13 into which the collar 7 with its contact chambers and contacts of the male connector 2 can be inserted.

At least one contact, here five contacts 14 according to the design of the male connector 2, projects from the base from which the collar 12 extends. In order to protect the contacts, each of the contacts 14 is surrounded by a shell 15. Each shell 15 surrounds a contact 14 almost completely, but not at the insertion region for the corresponding contact 9 of the male connector 2. Preferably, each shell 15 is designed in such a way that it surrounds the outer surface and the end remote from the base of the particular contact 14, but at the same time leaves open, on the end face remote from the base, an opening for insertion of the contact of the male connector 2.

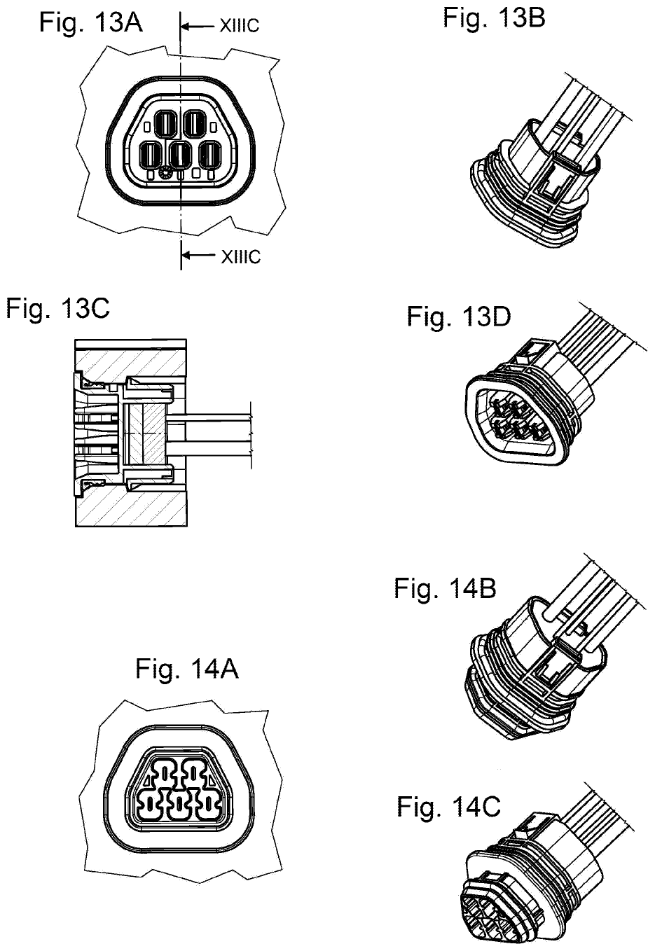

In particular, FIGS. 4 and 5 as well as in FIG. 13 (lower left illustration), show that two diametrally opposite recesses for receiving latch blades of the contact 14 (in particular of a socket contact in the exemplary embodiment) a formed on the shell 15 in addition to the insertion opening and serve for the primary locking of the contact in its contact chamber of the female connector 3. These recessed regions may or may not be provided.

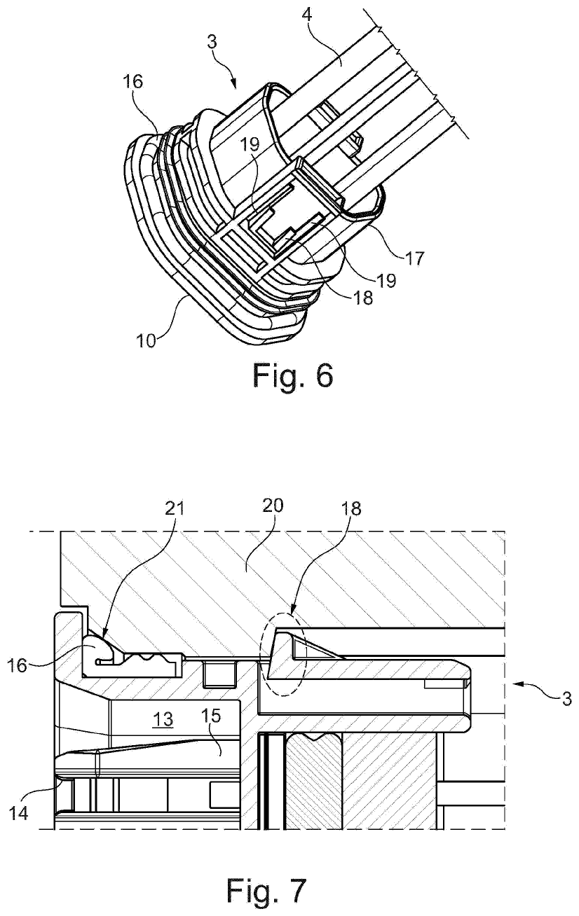

FIG. 6 shows a further design of the female connector 3. It can be seen that the housing of the female connector 3 has a ring seal 16 below its flange 10. The housing of the female connector 3 is shown at 17 in FIG. 6. A latch element 18 is provided on one side of the housing 17. This latch element 18 lies in a frame-like recess formed by the housing 17. The at least one latch element 18, fixes the female connector 3 at its installation location as intended. The same design as the female connector 3 can also be provided for the male connector 2.

FIG. 7 is a sectional view through the female connector 3. Here, the female connector 3 has been fixed at its installation location 20 as intended by the latch element 18. Furthermore, it can be seen that the seal 16 seals the outer surface of the housing 17 against the inner surface of the installation location 20. Furthermore, it can be seen very clearly in this FIG. 6 that the contact 14 is surrounded by the shell 15, with the end of the contact 14 pointing in the insertion direction (i.e. its outer end) is recessed relative to the outer end of the shell. For the purpose of facilitating the process of locating and plugging together the connectors, the opening of the installation location 20 has a chamfer 21. This chamfer 21 simplifies insertion of the female connector 3 into the installation location 20. To increase this effect, the generally annular end of the housing 17 facing the cable 4 is also provided with a corresponding chamfer or bevel. This is also shown in FIG. 7. This chamfer 21, which can be selected quite generously, creates a necessary surface for pressing the seal 16, in particular the O-ring, in order to orient the male connector 2 or female connector 3 almost or completely free of play in the installation location 20.

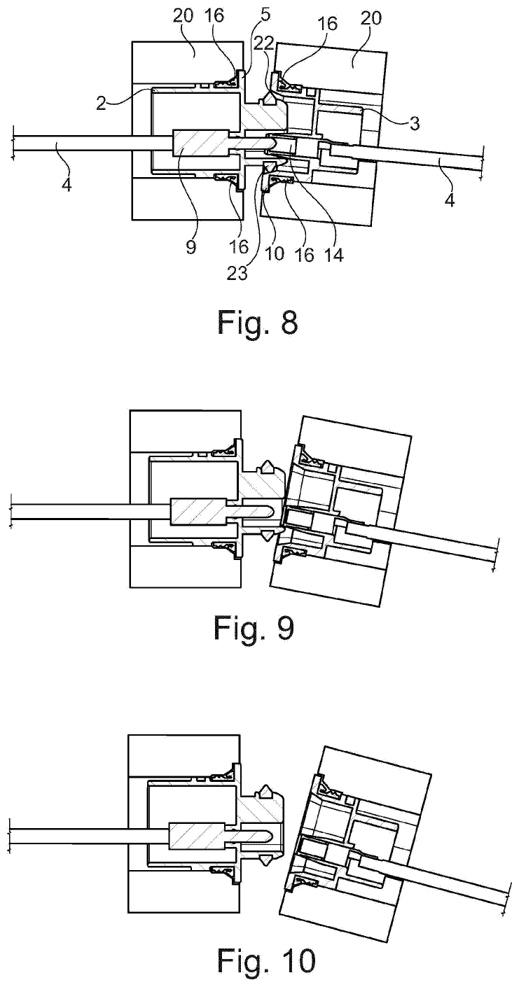

FIGS. 8, 9 and 10 show that the plug-in connection 1 according to the invention can be plugged together in different ways with its appropriately designed male connector 2 and the female connector 3 designed correspondingly thereto. Not shown, but possible in principle, is that the male connector 2 is oriented to the female connector 3 with its longitudinal axis aligned with the longitudinal axis of the female connector 3, and is then moved into the latter.

FIG. 8, on the other hand, shows that the male connector 2 and female connector 3 are moved at an angle to each other (here an angle of 5°) and are plugged together. In order to realize this plugging process and the following pivoting-in process, a part of the housing of the male connector 2 (again designed as a frame) projects beyond a front end of the installation location 20 of the male connector 2. Likewise, the female connector 3 is positioned with its housing in its associated installation location 20. Thus, with reference to FIG. 7, according to FIG. 8, the female connector 3 is fixed in the installation location 20 by its latch element 18, more specifically with the interposition of the seal 16.

Alternatively, it is conceivable that the male connector 2 or the female connector 3 are each fixed in the installation location 20 only by a latch element (in particular by the latch element 18), without a seal being provided for sealing and/or play-compensating and/or tolerance-compensating. For example, it is possible that the seal 16 might not have this particular form of a lip seal in the form of an O-ring, but could have another form of a lip seal.

In order to realize the by process and the subsequent pivoting-in process of the male connector 2 into the female connector 3, the generally annular front mating end of the housing of the female connector 3 has a generally annular bevel 22.

This bevel 22 of the female connector 3 corresponds with a chamfer on the front face of a collar of the housing of the male connector 2. Thus, the corresponding bevels of the male connector 2 and the female connector 3 can slide on each other during locating and subsequent pivoting in. The direction from which the male connector 2 is located to the female connector 3 (or vice versa) is irrelevant here, since both bevels are provided circumferentially. In such cases, the housings of male connector 2 and female connector 3 have a symmetrical cross-section with respect to their insertion axis (such as square, round or the like).

However, the plug-in connection of the exemplary embodiment (also referred to as contact system) allows the above-described oblique insertion angle of, for example, 15° only in one axis. In the other axis, only oblique insertion angles deviating from this (smaller or larger than 15°, such as only 5°) are possible with this plug-in connection. In such cases, the housings of male connector 2 and female connector 3 have an asymmetrical cross-section with respect to their insertion axis (such as rectangular, oval or the like).

In addition, for the purpose of a defined plugging-together process, the housing should be designed correspondingly so that it pivots in from a defined direction (as shown in FIGS. 7 to 9).

The pivoting-in process following the initial fitting together is furthermore also supported by a seal 23 in the front end-face region of the protruding collar of the male connector 2. This seal 23 allows the male connector 2 to slide over the bevel 22 and subsequently over the inner surface of the collar of the housing of the female connector 3 during the pivoting-in process. This not only facilitates the pivoting-in process, but the inner region of the plugged-together plug-in connection 1 is effectively sealed by the seal 23 in order to achieve or to assist longitudinal water tightness.

The same process as described above is also carried out in the locating and pivoting-in process as shown in FIGS. 9 and 10. This means that the male connector 2 can be located and pivoted in at different angles not aligned with the longitudinal axis of the plug-in connection 1.

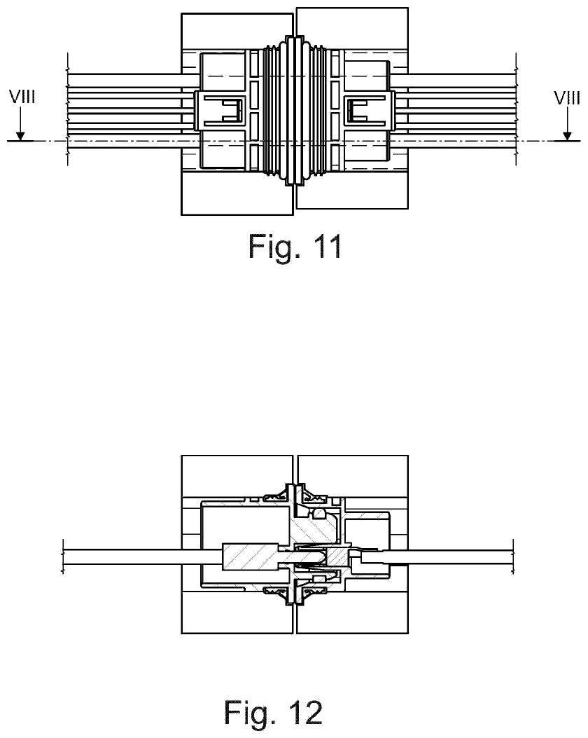

Furthermore, if FIGS. 10, 9 and 8 are viewed in a different manner (i.e. in this chronological order as opposed to individually as described above), it can be seen that the male connector 2 can initially be located at a greater angle with respect to the female connector 3. This is shown by way of example in FIG. 10 at an angle of 15°. If the front ends of the male connector 2 and of the female connector 3 come into contact (FIG. 9), it is still possible that these two elements do not have to be aligned with each other. Indeed, in FIG. 9, it is shown that after the positioning process (FIG. 10), the angle has been reduced and is further reduced during the subsequent pivoting-in process (FIG. 8), so that finally, after the plugging-together process has been fully performed, the male connector 2 is plugged together as intended with the female connector 3 to form an operational plug-in connection 1. This is illustrated in FIGS. 11 and 12.

Furthermore, when looking at FIGS. 10, 9 and 8, the protection against contact can be seen very well. Both the at least one contact of the male connector 2 and the at least one associated contact of the female connector 3 are effectively protected against contact by their recessed position and their shell, before the two elements have been fully plugged together. In particular in FIG. 8 it is furthermore clearly visible that also shortly after the male connector 2 has been located on the female connector 3 (or vice versa) the contact 9 of the male connector 2 starts to move into the contact 14 of the female connector 3, wherein, up to the position shown in FIG. 8, the contacts 9, 14 are protected from contact and only thereafter come into operative connection with each other, while they are on the one hand electrically contacted, but on the other hand are still effectively protected from contact by the recessed position of the contact 9 in the male connector 2 and the shell of the contact 14 of the female connector 3.

For the sake of completeness, FIG. 13 again shows various views of the female connector 3 according to the invention, and FIG. 14 shows various views of the associated male connector 2 according to the invention.

List of reference signs

| | |
|---|---|
| 1 | Plug-in connection |
| 2 | Male connector |
| 3 | Female connector |
| 4 | Cable |
| 5 | Flange |
| 6 | Hole |
| 7 | Collar |
| 8 | Contact chamber |
| 9 | Contact |
| 10 | Flange |
| 11 | Hole |
| 12 | Collar |
| 13 | Contact chamber |
| 14 | Contact |
| 15 | Shell |
| 16 | Seal |
| 17 | Housing |
| 18 | Latch element |
| 19 | Frame-like recess |
| 20 | Installation location |
| 21 | Chamfer |
| 22 | Bevel |
| 23 | Seal |

1. A plug-in connection comprising a male connector and a female connector that can be plugged together, the male connector having a housing that has a flange and a collar forming at least one contact chamber holding a contact, the female connector having a housing and a collar forming a contact chamber holding at least one contact, each contact of the female connector being surrounded by a shell except at an insertion region for a respective one of the contacts of the male connector.

2. The plug-in connection according to claim 1, wherein a seal is provided in a free end region of the collar of the male connector and a bevel cooperating with the seal during the plugging process is provided in a free end region of the collar of the female connector.

3. The plug-in connection according to claim 1, wherein the male connector and/or the female connector has a latch element for the latching fixation at its intended installation location.

4. The plug-in connection according to claim 3, wherein the male connector and/or the female connector has a seal between the installation location and the housing of the male connector or of the female connector after being fixed at its intended installation location.

5. The plug-in connection according to claim 1, wherein the flange of the housing of the male connector has at least one hole and/or the housing of the female connector has a flange with at least one hole.

6. A plug-in connection comprising:
a male connector having a housing formed with a collar extending axially from the housing and forming a plurality or axially outwardly open chambers each in turn having a free outer end;
respective male contacts fixed in the chambers of the male-connector housing, each extending axially, and each having an outer end recessed axially inward of the free outer end of the respective chamber;
a female connector having a housing formed with a collar snugly fittable around the male-connector collar and having a free outer end;
respective axially extending shells fixed to the female-connector housing in the respective chamber, fittable axially in the chambers of the male-connector housing, and each having a free outer end; and
respective female contacts fixed inside the female-connector shells, complementary to the male contacts, and each having an axial outer end recessed axially inward of the free outer end of the respective shell.

7. The connection according to claim 6, wherein each of the housings has a radially outwardly projecting mounting flange.
